(19) United States
(12) Patent Application Publication
(10) Pub. No.: US 2010/0132620 A1
(43) Pub. Date: Jun. 3, 2010

(54) AIR INFLATING AND DEFLATING FLOAT FOR MARINE CULTIVATION, MANUFACTURING METHOD THEREOF, AND VALVE USED THEREIN

(75) Inventors: Jang Hee Kim, Gyeongsangnam-do (KR); Jum Soo Seol, Busan-shi (KR)

Correspondence Address: J. Rodman Steele;Novak Druce & Quigg LLP, 525 Okeechobee Blvd, Suite 1500, West Palm Beach, FL, 33401, US

(73) Assignee: Nexen Corporation, Gyeongsangnam-do (KR)

(21) Appl. No.: 12/515,796

(22) PCT Filed: Jul. 21, 2008
(86) PCT No.: PCT/KR08/04244

§ 371 Date: May 21, 2009

(30) Foreign Application Priority Data
Jul. 25, 2007 (KR) 10-2007-0074415

(51) Int. Cl. A01K 61/00; B23P 11/00

(52) U.S. Cl. 119/239; 29/428

(57) ABSTRACT

Disclosed are an air inflating and deflating float for marine cultivation and a manufacturing method thereof. The air inflating and deflating float for marine cultivation includes a soft float body provided with a valve fixing part with an insertion hole, formed at the center thereof and connected to the inside of the float body, formed at one side of the float body; a valve inserted into the insertion hole of the valve fixing part, and provided with a through hole, through which air comes in and out, formed therein; and a protection cap inserted into the valve fixing part to prevent the air from being discharged via the through hole of the valve, and closing the through hole of the valve.

### TECHNICAL FIELD

The present invention relates to an air inflating and deflating float for marine cultivation and a manufacturing method thereof.

### BACKGROUND ART

In general, floats for cultivation mean floats for marine product cultivation, which are used in cultivation of marine products, such as oyster and layer, using buoyancy.

Marine products, such as oyster and layer, are cultivated on condition that ropes planted with seeds of the marine products are connected to floats.

The floats are fixed to the ropes, and float on the sea at regular intervals, thereby assisting the ropes to maintain a spreading state. Floats, which are widely used now, are made of Styrofoam, synthetic resin, a synthetic resin covering material, and EVA foam. However, 85% or more of floats, which are used at inshore fisheries in our country, are Styrofoam floats. Developed countries, have similar conditions to ours.

Styrofoam floats are broken by great waves caused by a typhoon, and contaminate the environment in international waters. Further, the buoyancy of the Styrofoam floats is lowered, as the Styrofoam floats absorb water, and it is difficult to recycle the Styrofoam floats.

Further, improved floats, which are made of synthetic resin, a synthetic resin covering material, and EVA foam to solve the above problems of the Styrofoam floats, are expensive, and the buoyancy of the improved floats is lowered, as time goes by. Moreover, it is still difficult to handle and recycle the improved floats. Thus, fishermen are reluctant to use the improved floats.

In order to solve the problems of the Styrofoam floats, many improved floats have been proposed. Among these improved floats, there is a float, into which air is injected. Korean Utility Model Laid-open Publication No. 1999-0039807 discloses a float with an air injection part.

The above float includes a float body, which is made of natural rubber, synthetic rubber, or soft synthetic resin and is provided with a rope connector, and an air injection part, through which air is injected into the float body.

However, since the air injection part to inject air into the float body is closed by a single lid, the float is easily deflated. Further, seawater permeates into the float body through a crack of a connection part to lower the buoyancy of the float, and the spherical shape of the float body increases resistance to waves.

### DISCLOSURE OF INVENTION

### Technical Problem

Therefore, the present invention has been made in view of the above problems, and it is an object of the present invention to provide an air inflating and deflating float for marine cultivation, which prevents the damage to the float due to a typhoon to prevent environmental contamination in international waters, is made of a material to maintain buoyancy on the surface of the water or under the water to prevent the decrease of buoyancy, allows air to freely come into and out of the float to cut down on expenses for conveyance and custody, and is conveniently is conveniently handled, and a manufacturing method thereof.

It is another object of the present invention to provide an air inflating and deflating float for marine cultivation, which has a double structure of an air injection hole to prevent air from leaking out, and allows air in a float body to be freely discharged to the outside of the float body, as occasion demands, and a manufacturing method thereof.

It is another object of the present invention to provide an air inflating and deflating float for marine cultivation, which has an asymmetrically streamlined outer surface having an oval shape to minimize resistance to waves and maximize buoyancy, and has a jointless integral structure to have an excellent adoptability to external environment, and a method for manufacturing the same.

It is yet another object of the present invention to provide a valve used in an air inflating and deflating float for marine cultivation, which is easily inserted into a float body and prevents the separation of the valve from the float body after the insertion of the valve into the float body, and allows air to be easily injected into the float but does not easily discharge the air in the float to the outside of the float unless a separate external force is applied to the valve.

### Technical Solution

In accordance with an aspect of the present invention, the above and other objects can be accomplished by the provision of a manufacturing method of an air inflating and deflating float for marine cultivation, comprising preparing a material for a float body, a material for a valve fixing part, and a material for a protection cap, respectively; manufacturing the protection cap by putting the material for the protection cap into a mold for the protection cap, and manufacturing the valve fixing part by putting the material for the valve fixing part into a mold for the valve fixing part, respectively; manufacturing the float body provided with the valve fixing part by inserting the valve fixing part into one side of a bi-axial rotation system serving as a mold for the float body and then putting the material for the float body into the bi-axial rotation system; and inserting a valve, separately manufactured, into the valve fixing part of the float body, and inserting the protection cap into the valve fixing part.

Preferably, the material for the float body, the material for the valve fixing part, and the material for the protection cap use PVC (PolyVinyl Chloride) for paste as a main ingredient.

More preferably, the material for the float body is prepared by adding 60˜70 part by weight of a plasticizer, 0.5˜8 part by weight of a stabilizer, and 0.1˜2 part by weight of a pigment to 100 part by weight of PVC for paste, the material for the valve fixing part is prepared by adding 40˜60 part by weight of a plasticizer, 25˜35 part by weight of a filler, 0.5˜8 part by weight of a stabilizer, 0.1˜2 part by weight of a pigment, and 3˜7 part by weight of a viscosity modifier to 100 part by weight of PVC for paste, and the material for the protection cap is prepared by adding 60˜70 part by weight of a plasticizer, 35˜45 part by weight of a filler, 0.5˜8 part by weight of a stabilizer, 0.1˜2 part by weight of a pigment, and 5˜10 part by weight of a viscosity modifier to 100 part by weight of PVC for paste.

Further, preferably, the material for the float body, the material for the valve fixing part, and the material for the protection cap use EVA (Ethylene Vinyl Acetate) as a main ingredient.

More preferably, the material for the float body is prepared by adding 40˜50 part by weight of a plasticizer, 5˜15 part by weight of a filler, 1˜8 part by weight of a stabilizer, 0.1˜2 part by weight of a pigment, 3˜10 part by weight of an impact modifier, and 0.1˜5 part by weight of a softener to 100 part by weight of EVA, the material for the valve fixing part is prepared by adding 50˜60 part by weight of a plasticizer, 20˜40 part by weight of a filler, 1˜8 part by weight of a stabilizer, 0.1˜2 part by weight of a pigment, 3˜10 part by weight of an impact modifier, and 0.1˜5 part by weight of a softener to 100 part by weight of EVA, and the material for the protection cap is prepared by adding 50˜70 part by weight of a plasticizer, 30˜50 part by weight of a filler, 1˜8 part by weight of a stabilizer, 0.1˜2 part by weight of a pigment, 3˜10 part by weight of an impact modifier, and 0.1˜5 part by weight of a softener to 100 part by weight of EVA.

In case that the material for the float body, the material for the valve fixing part, and the material for the protection cap use PVC for paste as a main ingredient, molds used preferably have a temperature of approximately 180˜210° C., and in case that the material for the float body, the material for the valve fixing part, and the material for the protection cap use EVA as a main ingredient, molds used preferably have a temperature of approximately 150˜190° C.

In case that the PVC for paste is used as a main ingredient, various additives are mixed with the main ingredient, the mixture is deaerated using a vacuum pump, foreign substances are removed from the mixture using a filter, and then mixture is matured for approximately 4 hours, thereby preparing each of the materials. In case that the EVA is used, various additives are mixed with a main ingredient, and the mixture is extruded by an extruder and cut into pellet-shaped pieces, thereby preparing each of the materials.

PVC for paste may be replaced with PE, and EVA powder may be replaced with PVC powder. PVC for paste has more excellent physical properties for the float than PE, and EVA powder has more excellent physical properties for the float than PVC powder.

Accordingly, in the present invention, PVC for paste and EVA are used as the main ingredient of each of the materials.

In accordance with another aspect of the present invention, there is provided an air inflating and deflating float for marine cultivation, comprising a soft float body provided with a valve fixing part with an insertion hole, formed at the center thereof and connected to the inside of the float body, formed at one side of the float body; a valve inserted into the insertion hole of the valve fixing part, and provided with a through hole, through which air comes in and out, formed in the valve; and a protection cap inserted into the valve fixing part to prevent the air from being discharged via the through hole of the valve, and closing the through hole of the valve, wherein a projection is formed on the outer surface of a valve body of the valve; a protrusion is formed on the lower portion of the insertion hole of the valve fixing part, and a screw part is formed on the upper portion of the insertion hole of the valve fixing part; a screw part is formed on the outer surface of the protection cap; and the projection of the valve is caught by the protrusion of the valve fixing part, and the screw part of the protection cap is screw-connected to the screw part of the valve fixing part.

Preferably, an O-ring for protecting the valve from external impact or foreign substances and preventing the deterioration of the function of the valve due to the penetration of seawater is formed on the protection cap.

Preferably, rope grooves, along which ropes are tied to the float body, and rope rings, into which the ropes are inserted, are formed at both sides of the outer surface of the float body.

Preferably, the valve of the air inflating and deflating float for marine cultivation includes a valve body provided with the protrusion formed on the outer surface thereof and the through hole formed therethrough and having a tapered shape, in which the width of the valve body is decreased from the upper portion of the valve body to the lower portion of the valve body; a spring inserted into the through hole of the valve body; and a ball elastically supported by the elastic force of the spring to close the through hole.

Further, preferably, the valve of the air inflating and deflating float for marine cultivation includes a valve body provided with the protrusion formed on the outer surface thereof and the through hole formed therethrough and having a tapered shape, in which the width of the valve body is decreased from the upper portion of the valve body to the lower portion of the valve body, and a valve core inserted into the through hole of the valve body; and a screw part is formed on the inner surface of the through hole of the valve, a screw part is formed on the outer surface of the upper portion of the valve core, and the screw part of the valve core is screw-connected to the screw part of the through hole of the valve.

The soft float body has a low hardness, and the valve fixing part has a higher hardness than that of the float body but does not have enough hardness to be broken by external pressure. The valve fixing part has enough ductility to prevent the valve body made of a metal from being separated from the valve fixing part after the valve is inserted into the valve fixing part, and has enough rigidity to screw-connect the protection cap having rigidity to the valve fixing part. Preferably, the float body has a hardness of 60˜70, and the valve fixing part has a hardness of 80˜90. Preferably, the protection cap has a higher hardness than that of the valve fixing part, i.e., 90 or more. However, the hardness of the float body, the hardness of the valve fixing part, and the hardness of the protection cap are not limited thereto, but those skilled in the art will appreciate that various modifications of the hardnesses of the float body, the valve fixing part, and the protection cap are possible as long as the float body, the valve fixing part, and the protection cap exhibit equal technical functions.

### ADVANTAGEOUS EFFECTS

The air inflating and deflating float for marine cultivation of the present invention includes a float body having an asymmetrically streamlined outer surface having an oval shape to minimize resistance to waves and maximize buoyancy, and includes rope grooves and rope rings formed on the outer surface of the float body to prevent the float from being separated from ropes even by a rattling wind, such as a typhoon.

Further, the air inflating and deflating float for marine cultivation of the present invention has a jointless integral structure and is made of a soft material to prevent the damage to the float due to a typhoon, has a double structure of an air injection hole, including a valve and a protection cap, to prevent air from leaking out, and allows air to be freely injected into or discharged from the float body. Further, the air inflating and deflating float for marine cultivation of the present invention allows air to freely come into and out of the float body to cut down on expenses for conveyance and custody, and is conveniently treated.

Moreover, the valve used in the air inflating and deflating float for marine cultivation employs a valve core, which is widely used in vehicle tires, to reduce a production cost, and effectively controls the coming of air into and out of the float body.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates an air inflating and deflating float for marine cultivation in accordance with a preferred embodiment of the present invention;

FIG. 2 illustrates an enlarged portion of the air inflating and deflating float for marine cultivation in accordance with the preferred embodiment of the present invention;

FIG. 3 illustrates one embodiment of a valve used in the air inflating and deflating float for marine cultivation in accordance with the preferred embodiment of the present invention; and

FIG. 4 illustrates another embodiment of a valve used in the air inflating and deflating float for marine cultivation in accordance with the preferred embodiment of the present invention.

### BEST MODE FOR CARRYING OUT THE INVENTION

Now, preferred embodiments of the present invention will be described in detail with reference to the annexed drawings.

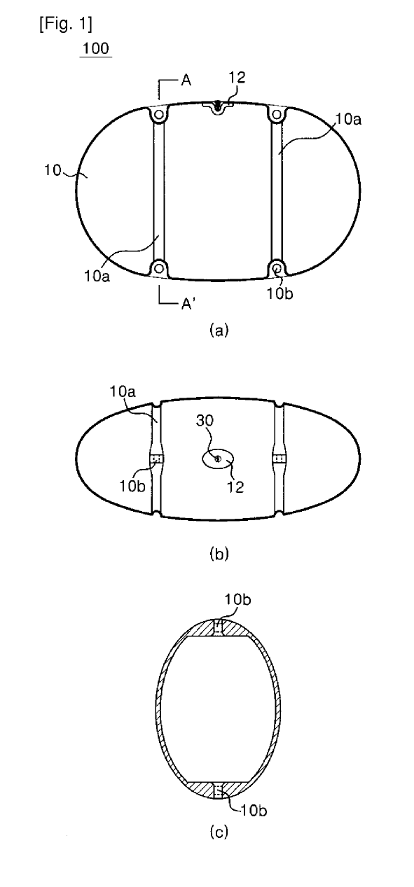

FIG. 1 schematically illustrates an air inflating and deflating float for marine cultivation in accordance with a preferred embodiment of the present invention. FIG. 1A is a plan view of the float when the float is floated on the surface of seawater, FIG. 1B is a side view (or a front or rear view according to viewing angles) of the float, and FIG. 1C is a cross-sectional view of the float taken along the line A-A of FIG. 1A.

With reference to FIG. 1, an air inflating and deflating float 100 for marine cultivation of the present invention has an asymmetrically streamlined structure, the outer surface of which has an oval shape. More specifically, the area of the float 100 viewed from the top (FIG. 1A) is larger than the area of the float 100 view from the side or the front (FIG. 1B or 1C). That is, the float 100 has an asymmetrically streamlined structure, in which the cross-sectional area of a portion of the float 100 contacting the surface of seawater (FIG. 1A) is larger than the cross-sectional area of the side surface of the float 100 (FIG. 1B or 1C). This structure serves to minimize the resistance of the float 100 to waves and maximize the buoyancy of the float 100.

Rope grooves 10a are formed at both sides of the outer surface of a float body 10, along which ropes are tied to the float body 10, and rope rings 10b, into which the ropes are respectively inserted, are formed at both sides of the rope grooves 10a. The rope grooves 10a and the rope rings 10b serve to firmly connect marine products to be cultivated with the float 100 and protect the marine products from great waves due to a typhoon or windstorm. The rope grooves 10a and the rope rings 10b are designed such that the ropes are firmly connected to the float 100 through the rope grooves 10a and the rope rings 10b to prevent the separation of the float 100 from the ropes.

A valve fixing part 12 is formed at the center of the upper portion of the float body 10. The float body 10 has softness, but the valve fixing part 12 has rigidity compared with the float body 10.

A valve fixing part 12 is a part, to which a valve and a protection cap are attached, and a constitution thereof will be described in detail, as follows.

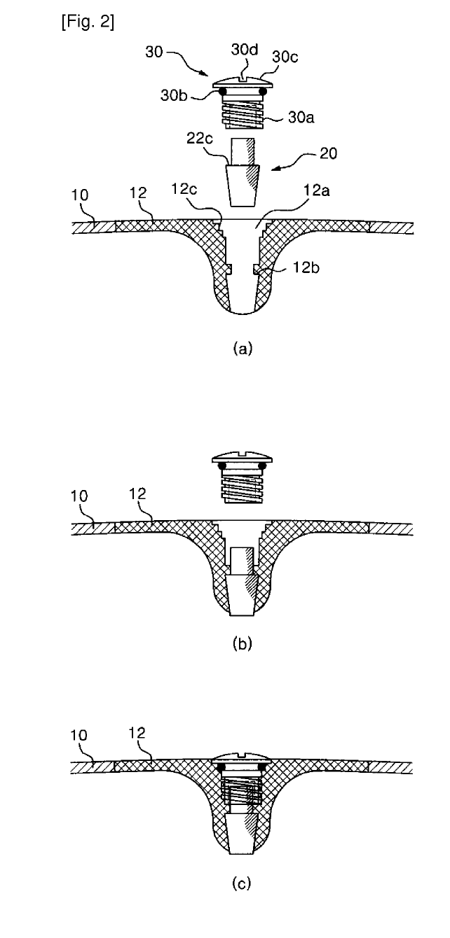

FIG. 2 illustrates an enlarged portion of the air inflating and deflating float for marine cultivation in accordance with the preferred embodiment of the present invention, and particularly illustrates the valve fixing part 12 formed at one side of the float body 10.

FIG. 2A illustrates the valve fixing part 12 before a valve 20 and a protection cap 30 are inserted into an insertion hole 12a of the valve fixing part 12, FIG. 2B illustrates the valve fixing part 12 after the valve 20 is inserted into the insertion hole 12a of the valve fixing part 12, and FIG. 2C illustrates the valve fixing part 12 after the protection cap 30 is fixed.

With reference to FIG. 2, the valve fixing part 12 formed at one side of the float body 10 is provided with the insertion hole 12a, which is formed at the center thereof and is connected to the inside of the float. A protrusion 12b is formed on the lower portion of the insertion hole 12a of the valve fixing part 12, and a screw part 12c is formed on the upper portion of the insertion hole 12a of the valve fixing part 12. The protrusion 12b allows a projection 22c formed on the outer surface of a valve body 22 to be caught by the protrusion 12b to prevent the valve 20 from being separated from the insertion hole 12a after valve 20 is inserted into the insertion hole 12a. The screw part 12c is screw-connected to a screw part 30a formed on the outer surface of the protection cap 30 to cause the protection cap 30 to be inserted into the insertion hole 12a.

The valve fixing part 12 has ductility to have enough frictional force to prevent the valve 20 from being separated from the valve fixing part 12 after the valve 20 is inserted into the valve fixing part 12, and has enough rigidity to screw-connect the protection cap 30 having rigidity to the valve fixing part 12. Thus, the valve fixing part 12 preferably has a hardness of approximately 80˜90.

The valve 20 includes the valve body 22 made of metal, and a through hole 22a is formed through the valve body 22 such that air is injected into and discharged from the float via the through hole 22a. The valve body 22 is preferably made of brass having a high corrosion resistance. Preferred embodiments of the valve 20 will be described in detail later.

The protection cap 30 is connected to the valve fixing part 12 so as to close the through hole 22a formed through the valve 20. The protection cap 30 is screw-connected to the valve fixing part 12 by the screw part 30a formed on the outer surface of the protection cap 30. An O-ring 30b, which protects the valve 20 from external impact or foreign substances and prevents the deterioration of the function of the valve 20 due to the penetration of seawater, is formed on the outer surface of the upper portion of the screw part 30a of the protection cap 30. The O-ring 30b is preferably made of soft rubber. A driver groove 30d is formed on a head 30c of the protection cap 30. Thereby, the protection cap 30 is rotated using a tool, such as a driver, and thus is connected to the valve fixing part 12.

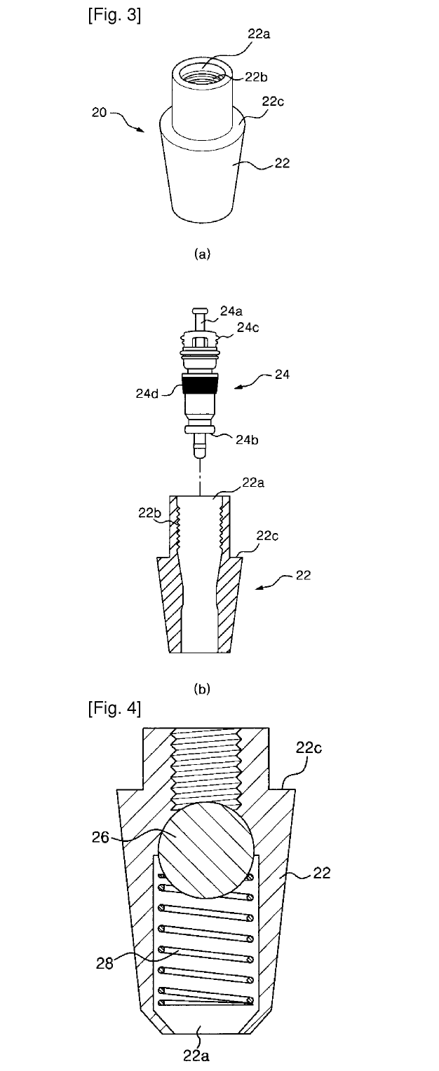

FIG. 3 illustrates one embodiment of the valve used in the air inflating and deflating float for marine cultivation in accordance with the preferred embodiment of the present invention.

FIG. 3A is a perspective view of the valve 20, and FIG. 3B is an exploded cross-sectional view of the valve 20.

With reference to FIG. 3, the valve 20 includes a valve body 22, and a valve core 24.

A through hole 22a is formed through the valve body 22, and a projection 22c is formed on the outer surface of the valve body 22. The outer surface of the valve body 22 has a tapered shape, in which the width of the valve body 22 is gradually decreased from the upper portion of the valve body 22 to the lower portion of the valve body 22. This shape of the valve body 22 allows the valve body 22 to be easily inserted into the valve fixing part 12. The valve body 22 is made of a metal having a high corrosion resistance, for example, bronze.

The valve core 24 is inserted into the through hole 22a of the valve body 22, and controls the injection and discharge of air into and from the float. Generally, the valve core 24 employs a valve core, which is widely used in vehicle tires. The valve core, which is used in vehicle tires, serves to control air injected into the tires. This valve core is used also in the float of the present invention.

A screw part 24c is formed on the upper portion of the valve core 24, and is screw-connected to a screw part 22b formed on the inner surface of the through hole 22a of the valve body 22. An upper protruding switch 24a and a lower opening and shutting plate 24b are connected, and thus when the upper protruding switch 24a is pressed, the lower opening and shutting plate 24b descends and discharges air to the outside of the valve core 24. A spring (not shown), which elastically supports the lower opening and shutting plate 24b, is formed in the valve core 24. Further, a packing 24d, which maintains the airtight state of the float when the valve core 24 is inserted into the through hole 22a of the valve body 22, is formed at a designated position of the outer surface of the valve core 24.

The valve 20 shown in FIG. 3 is proper for a case that an air pressure in the float is comparatively high, i.e., a high-pressure case.

FIG. 4 illustrates another embodiment of the valve used in the air inflating and deflating float for marine cultivation in accordance with the preferred embodiment of the present invention.

The valve 20 shown in FIG. 4 includes a valve body 22, a spring 28 formed in the valve body 22, and a ball 26 elastically supported by the spring 28.

A projection 22c is formed on the outer surface of the valve body 22, and the outer surface of the valve body 22 has a tapered shape, in which the width of the valve body 22 is gradually decreased from the upper portion of the valve body 22 to the lower portion of the valve body 22. A through hole 22a, through which air is injected into and discharged from the float, is formed through the valve body 22.

The spring 28 inserted into the through hole 22a of the valve body 22 elastically supports the ball 26. The ball 26 is preferably made of a metal, and serves to close the through hole 22a due to the elastic force of the spring 28 to maintain the airtight state of the float. The valve 20 shown in FIG. 4 is proper for a case that an air pressure in the float is comparatively low, i.e., a low-pressure case.

Hereinafter, examples of a manufacturing method of the air inflating and deflating float for marine cultivation of the present invention will be described.

### Example 1

First, a material for a float body was prepared. PVC (PolyVinyl Chloride) powder for paste was used as a main ingredient. Here, the PVC powder for paste denotes PVC powder, which comes into an emulsion state when a plasticizer or a stabilizer is added to the PVC powder. After 1 kg of the PVC powder was put into a mixer, 650 g of a plasticizer, 40 g of a stabilizer, and 10 g of a pigment were added to the PVC powder, and then all ingredients were sufficiently mixed for 10 minutes. Since the mixture contains air bubbles, the mixture was deaerated using a vacuum pump. In order to remove foreign substances from the mixture, the deaerated mixture passed through a filter. The filtered product was matured for 4 hours. Thereby, the preparation of the material for the float body was completed.

A material for a valve fixing part and a material for a protection cap were respectively prepared by the same method.

The material for the valve fixing part was obtained by adding 500 g of a plasticizer, 300 g of a filler (calcium carbonate), 40 g of a stabilizer, 10 g of a pigment, 50 g of a viscosity modifier into 1 kg of PVC powder for paste, mixing all ingredients in a mixer for 10 minutes, deaerating and filtering the mixture, and then maturing the mixture for 4 hours. Thereby, the preparation of the material for the valve fixing part was completed.

The material for the protection cap was obtained by adding 600 g of a plasticizer, 400 g of a filler (calcium carbonate), 40 g of a stabilizer, 10 g of a pigment, 70 g of a viscosity modifier into lkg of PVC powder for paste, mixing all ingredients in a mixer, and deaerating, filtering, and maturing the mixture by the same method. Thereby, the preparation of the material for the protection cap was completed.

Since the material for the float body, the material for the valve fixing part, and the material for the protection cap use PVC powder for paste as the main ingredient, when a plasticizer is applied to the materials, the materials come into an emulsion state. It is preferable that the material for the float body has a viscosity of 3,500˜6,500 cps, the material for the valve fixing part has a viscosity of 5,500˜8,500 cps, and the material for the protection cap has a viscosity of 7,500˜9,500 cps. Since the valve fixing part and the protection cap must have rigidity compared with the float body when a product is completed, the material for the valve fixing part and the material for the protection cap contained the filler.

After a small amount of the matured material for the valve fixing part was inserted into a mold for the valve fixing part, the material passed through swelling, gelation, and fusion processes, while maintaining a temperature of approximately 200° C. for 20 minutes, and thus the valve fixing part was produced.

Further, after a small amount of the matured material for the protection cap was inserted into a mold for the protection cap, the material passed through swelling, gelation, and fusion processes, while maintaining a temperature of approximately 200° C. for 20 minutes, and thus the protection cap was produced.

Then, after the valve fixing part was inserted into a mold for the float body, the matured material for the float body was put into the mold. Here, a bi-axial rotation system was used as the mold for the float body to form the float body having a designated hemispheric shape.

After the material for the float body was put into the mold, the material passed through swelling, gelation, and fusion processes, while maintaining a temperature of approximately 200° C. for 20 minutes. Air in the swollen material for the float body is exhausted using a vacuum pump, and as occasion demands, a releasing agent is sprayed onto the material such that float bodies cannot stick to each other in case that the float bodies are vacuum-packed. After the product was taken out of the mold, the product was naturally cooled. Thereby, a float body having a valve fixing part was produced.

A valve, which was designed to be suitable for the function of the product and was separately produced, was inserted into the valve fixing part. A prepared O-ring was inserted into an O-ring connection groove of the produced protection cap, and then the protection cap, to which the O-ring is connected, was connected to the valve fixing part.

### Example 2

Differing from Example 1, Example 2 used EVA (Ethylene Vinyl Acetate) powder as a main ingredient.

First, a material for a float body was prepared. After lkg of the EVA powder was put into a mixer, 450 g of a plasticizer, 100 g of a filler, 30 g of a stabilizer, 10 g of a pigment, 80 g of an impact modifier, and 20 g of a softener were added to the EVA powder, and then all ingredients were sufficiently mixed for 10 minutes. The mixture was put into an extruder, and was extruded. The extruded mixture was cooled, and was cut at designated intervals (3˜4 mm) into pellet-shaped pieces. Thereby, the preparation of the material for the float body was completed.

A material for a valve fixing part and a material for a protection cap were respectively prepared by the same method.

The material for the valve fixing part was obtained by adding 550 g of a plasticizer, 300 g of a filler, 30 g of a stabilizer, 10 g of a pigment, 50 g of an impact modifier, and 20 g of a softener into 1 kg of EVA powder and mixing all ingredients in a mixer for 10 minutes. The mixture was put into an extruder, and was extruded. The extruded mixture was cooled, and was cut at designated intervals (3˜4 mm) into pellet-shaped pieces. Thereby, the preparation of the material for the valve fixing part was completed.

The material for the protection cap was obtained by adding 600 g of a plasticizer, 400 g of a filler (calcium carbonate), 40 g of a stabilizer, 10 g of a pigment, and 70 g of a modifier into lkg of EVA powder and mixing all ingredients in a mixer for 10 minutes. The mixture was put into an extruder, and was extruded. The extruded mixture was cooled, and was cut at designated intervals (3˜4 mm) into pellet-shaped pieces. Thereby, the preparation of the material for the protection cap was completed.

Since the valve fixing part and the protection cap must have rigidity compared with the float body when a product is completed, the material for the valve fixing part and the material for the protection cap contained a larger amount of the filler than that of the material for the float body.

After the pellet-shaped material for the valve fixing part was inserted into a mold for the valve fixing part, the material was melted, while maintaining a temperature of approximately 170? for a designated time, and then was cooled, and thus the valve fixing part was produced.

Further, after the pellet-shaped material for the protection cap was inserted into a mold for the protection cap, the material was melted, while maintaining a temperature of approximately 170° C. for a designated time, and then was cooled, and thus the protection cap was produced.

Then, after the valve fixing part was inserted into a mold for the float body, the matured material for the float body was put into the mold. Here, a bi-axial rotation system was used as the mold for the float body to form the float body having a designated hemispheric shape.

After the material for the float body was put into the mold, the material was melted, while maintaining a temperature of approximately 170° C. for a designated time. Air in the swollen material for the float body is exhausted using a vacuum pump, and as occasion demands, a releasing agent is sprayed onto the material such that float bodies cannot stick to each other in case that the float bodies are vacuum-packed. After the product was taken out of the mold, the product was naturally cooled. Thereby, a float body having a valve fixing part was produced.

A valve, which was designed to be suitable for the function of the product and was separately produced, was inserted into the valve fixing part. A prepared O-ring was inserted into an O-ring connection groove of the produced protection cap, and then the protection cap, to which the O-ring is connected, was connected to the valve fixing part.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A manufacturing method of an air inflating and deflating float for marine cultivation, comprising:
preparing a material for a float body, a material for a valve fixing part, and a material for a protection cap, respectively;
manufacturing the protection cap by putting the material for the protection cap into a mold for the protection cap, and manufacturing the valve fixing part by putting the material for the valve fixing part into a mold for the valve fixing part, respectively;
manufacturing the float body provided with the valve fixing part by inserting the valve fixing part into one side of a bi-axial rotation system serving as a mold for the float body and then putting the material for the float body into the bi-axial rotation system; and
inserting a valve, separately manufactured, into the valve fixing part of the float body, and inserting the protection cap into the valve fixing part.

2. The method according to claim 1, wherein the material for the float body, the material for the valve fixing part, and the material for the protection cap use PVC (PolyVinyl Chloride) for paste as a main ingredient.

3. The method according to claim 1, wherein the material for the float body is prepared by adding 60-70 part by weight of a plasticizer, 0.5-8 part by weight of a stabilizer, and 0.1-2 part by weight of a pigment to 100 part by weight of PVC for paste, the material for the valve fixing part is prepared by adding 40-60 part by weight of a plasticizer, 25-35 part by weight of a filler, 0.5-8 part by weight of a stabilizer, 0.1-2 part by weight of a pigment, and 3-7 part by weight of a viscosity modifier to 100 part by weight of PVC for paste, and the material for the protection cap is prepared by adding 60-70 part by weight of a plasticizer, 35-45 part by weight of a filler, 0.5-8 part by weight of a stabilizer, 0.1-2 part by weight of a pigment, and 5-10 part by weight of a viscosity modifier to 100 part by weight of PVC for paste.

4. The method according to claim 1, wherein the material for the float body, the material for the valve fixing part, and the material for the protection cap use EVA (Ethylene Vinyl Acetate) as a main ingredient.

5. The method according to claim 1, wherein the material for the float body is prepared by adding 40-50 part by weight of a plasticizer, 5-15 part by weight of a filler, 1-8 part by weight of a stabilizer, 0.1-2 part by weight of a pigment, 3-10 part by weight of an impact modifier, and 0.1-5 part by weight of a softener to 100 part by weight of EV A, the material for the valve fixing part is prepared by adding 50-60 part by weight of a plasticizer, 20-40 part by weight of a filler, 1-8 part by weight of a stabilizer, 0.1-2 part by weight of a pigment, 3-10 part by weight of an impact modifier, and 0.1-5 part by weight of a softener to 100 part by weight of EV A, and the material for the protection cap is prepared by adding 50-70 part by weight of a plasticizer, 30-50 part by weight of a filler, 1-8 part by weight of a stabilizer, 0.1-2 part by weight of a pigment, 3-10 part by weight of an impact modifier, and 0.1-5 part by weight of a softener to 100 part by weight of EV A.

6. An air inflating and deflating float for marine cultivation, comprising:
a soft float body provided with a valve fixing part with an insertion hole, formed at the center thereof and connected to the inside of the float body, formed at one side of the float body;
a valve inserted into the insertion hole of the valve fixing part, and provided with a through hole, through which air comes in and out, formed in the valve; and
a protection cap inserted into the valve fixing part to prevent the air from being discharged via the through hole of the valve, and closing the through hole of the valve, wherein:
a projection is formed on the outer surface of a valve body of the valve;
a protrusion is formed on the lower portion of the insertion hole of the valve fixing part, and a screw part is formed on the upper portion of the insertion hole of the valve fixing part;
a screw part is formed on the outer surface of the protection cap; and
the projection of the valve is caught by the protrusion of the valve fixing part, and the screw part of the protection cap is screw-connected to the screw part of the valve fixing part.

7. The air inflating and deflating float for marine cultivation according to claim 6,
wherein an O-ring for protecting the valve from external impact or foreign substances and preventing the deterioration of the function of the valve due to the penetration of seawater is formed on the protection cap.

8. The air inflating and deflating float for marine cultivation according to claim 6, wherein:
the valve includes the valve body, through which the through hole is formed, and a valve core inserted into the through hole of the valve body; and
a screw part is formed on the inner surface of the through hole of the valve, a screw part is formed on the outer surface of the upper portion of the valve core, and the screw part of the valve core is screw-connected to the screw part of the through hole of the valve.

9. The air inflating and deflating float for marine cultivation according to claim 6, wherein the valve includes the valve body, through which the through hole is formed, a spring inserted into the through hole of the valve body, and a ball elastically supported by the elastic force of the spring to close the through hole.

10. The air inflating and deflating float for marine cultivation according to claim 6, wherein rope grooves, along which ropes are tied to the float body, and rope rings, into which the ropes are inserted, are formed at both sides of the outer surface of the float body.

11. The air inflating and deflating float for marine cultivation according to claim 6, wherein the float body has an asymmetrically streamlined structure, the outer surface of which has an oval shape, such that the cross-sectional area of a portion of the float body contacting the surface of seawater is larger than the cross-sectional area of the side surface of the float body, so as to minimize resistance to waves and maximize the buoyancy of the float body.
